(19) United States
(12) Patent Application Publication
(10) Pub. No.: US 2002/0032710 A1
(43) Pub. Date: Mar. 14, 2002

(54) Processing architecture having a matrix-transpose capability

(76) Inventors: Ashley Saulsbury, Los Altos, CA (US); Daniel S. Rice, Oakland, CA (US); Michael W. Parkin, Palo Alto, CA (US); Nyles Nettleton, Campbell, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/802,020

(22) Filed: Mar. 8, 2001

Related U.S. Application Data
(60) Provisional application No. 60/187,779, filed on Mar. 8, 2000.

(51) Int. Cl. G06F 17/14; G06F 9/00

(52) U.S. Cl. 708/400; 712/221; 712/24; 712/4

(57) ABSTRACT

According to the invention, a matrix of elements is processed in a processor. A first subset of matrix elements is loaded from a first location and a second subset of matrix elements is loaded from a second location. A third subset of matrix elements is stored in a first destination and a fourth subset of matrix elements is stored in a second destination. The loading and storing steps result from the same instruction issue.

### CROSS-REFERENCES TO RELATED APPLICATIONS

This application claims the benefit of U.S. Provisional Application No. 60/187,779 filed on Mar. 8, 2000.

This application is being filed concurrently with related U.S. patent applications: Attorney Docket Number 016747-00991, entitled “VLIW Computer Processing Architecture with On-chip DRAM Usable as Physical Memory or Cache Memory”; Attorney Docket Number 016747-01001, entitled “VLIW Computer Processing Architecture Having a Scalable Number of Register Files”; Attorney Docket Number 016747-01780, entitled “Computer Processing Architecture Having a Scalable Number of Processing Paths and Pipelines”; Attorney Docket Number 016747-01051, entitled “VLIW Computer Processing Architecture with On-chip Dynamic RAM”; Attorney Docket Number 016747-01211, entitled “Computer Processing Architecture Having the Program Counter Stored in a Register File Register”; Attorney Docket Number 016747-01461, entitled “Processing Architecture Having Parallel Arithmetic Capability”; Attorney Docket Number 016747-01471, entitled “Processing Architecture Having an Array Bounds Check Capability”; Attorney Docket Number 016747-01481, entitled “Processing Architecture Having an Array Bounds Check Capability”; and, Attorney Docket Number 016747-01531, entitled “Processing Architecture Having a Compare Capability”; all of which are incorporated herein by reference.

### BACKGROUND OF THE INVENTION

The present invention relates generally to an improved computer processing instruction set, and more particularly to an instruction for performing a matrix transpose.

Computer architecture designers are constantly trying to increase the speed and efficiency of computer processors. For example, computer architecture designers have attempted to increase processing speeds by increasing clock speeds and attempting latency hiding techniques, such as data prefetching and cache memories. In addition, other techniques, such as instruction-level parallelism using VLIW, multiple-issue superscalar, speculative execution, scoreboarding, and pipelining are used to further enhance performance and increase the number of instructions issued per clock cycle (IPC).

Architectures that attain their performance through instruction-level parallelism seem to be the growing trend in the computer architecture field. Examples of architectures utilizing instruction-level parallelism include single instruction multiple data (SIMD) architecture, multiple instruction multiple data (MIMD) architecture, vector or array processing, and very long instruction word (VLIW) techniques. Of these, VLIW appears to be the most suitable for general purpose computing. However, there is a need to further achieve instruction-level parallelism through other techniques.

Performing graphics manipulation more efficiently is of paramount concern to modem microprocessor designers. Graphics operations, such as image compression, rely heavily upon performing matrix transpose operations. Transposing a matrix involves rearranging the columns of the matrix as rows. Conventional processors require tens of instructions to transpose a matrix. Accordingly, there is a need to reduce the number of instructions necessary to perform a matrix transpose such that code efficiency is increased.

### SUMMARY OF THE INVENTION

The present invention performs matrix transpose operations in an efficient manner. In one embodiment, a matrix of elements is processed in a processor. A first subset of matrix elements is loaded from a first location and a second subset of matrix elements is loaded from a second location. A third subset of matrix elements is stored in a first destination and a fourth subset of matrix elements is stored in a second destination. The loading and storing steps result from the same instruction issue.

A more complete understanding of the present invention may be derived by referring to the detailed description of preferred embodiments and claims when considered in connection with the figures, wherein like reference numbers refer to similar items throughout the figures.

### BRIEF DESCRIPTION OF THE DRAWINGS

FIG. 1 is a block diagram of an embodiment of a processor chip having the processor logic and memory on the same integrated circuit;

FIG. 2 is block diagram illustrating one embodiment of a processing core having a four-way VLIW pipeline design;

FIG. 3 is a diagram showing some of the data types generally available to the processor chip;

FIG. 4 is a diagram showing one embodiment of machine code syntax for a matrix transpose sub-instruction;

FIG. 5 is diagram which shows the source and destination registers after transposing the matrix;

FIG. 6A is diagram illustrating an embodiment of the operation of two sub-instructions that transpose a portion of the matrix;

FIG. 6B is diagram that illustrates an embodiment of the operation of two sub-instructions that transpose another portion of the matrix;

FIG. 7 is a block diagram which schematically illustrates an embodiment of operation of the first two sub-instructions which transpose the first and third rows of the matrix;

FIG. 8 is a block diagram that schematically illustrates one embodiment of operation of the last two sub-instructions that transpose the second and fourth rows of the matrix;

FIG. 9 is a flow diagram of an embodiment of a method that transposes the columns of a matrix to rows; and

FIG. 10 is a block diagram that schematically illustrates another embodiment of the operation that successively transposes all rows of the matrix.

### DESCRIPTION OF THE SPECIFIC EMBODIMENTS

### Introduction

The present invention provides a novel computer processor chip having sub-instructions for transforming a matrix of elements. Additionally, embodiments of this sub-instruction allow performing a matrix transpose in as little as one or two very long instruction words (VLIW). As one skilled in the art will appreciate, performing a matrix transpose with specialized instructions increases the instructions issued per clock cycle (IPC). Furthermore, by combining these transpose sub-instructions with a VLIW architecture additional efficiencies are achieved.

In the Figures, similar components and/or features have the same reference label. Further, various components of the same type are distinguished by following the reference label by a dash and a second label that distinguishes among the similar components. If only the first reference label is used in the specification, the description is applicable to any one of the similar components having the second label.

### Processor Overview

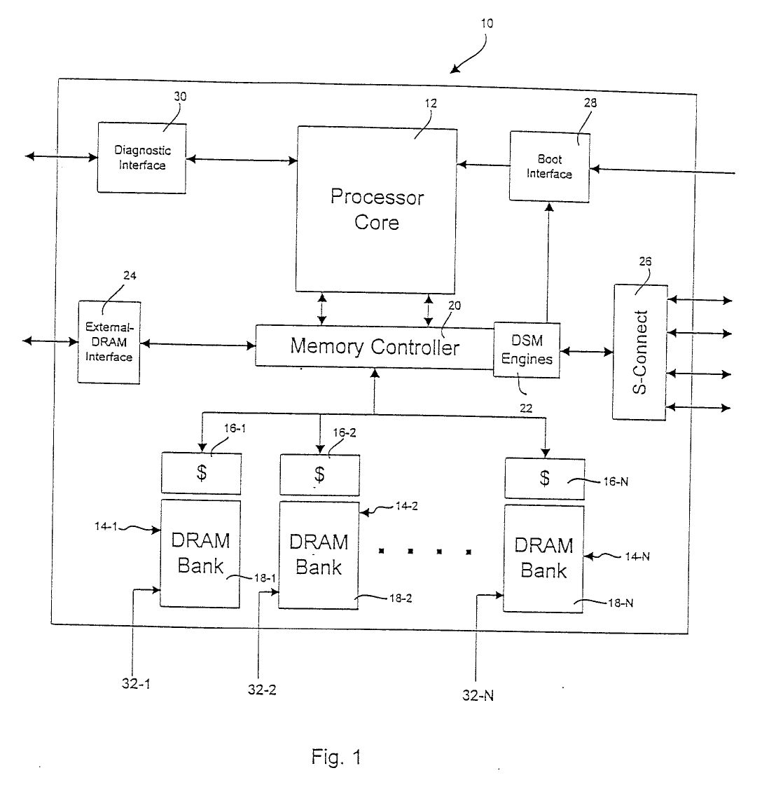

With reference to FIG. 1, a processor chip 10 is shown which embodies the present invention. In particular, processor chip 10 comprises a processing core 12, a plurality of memory banks 14, a memory controller 20, a distributed shared memory controller 22, an external memory interface 24, a high-speed I/O link 26, a boot interface 28, and a diagnostic interface 30.

As discussed in more detail below, processing core 12 comprises a scalable VLIW processing core, which may be configured as a single processing pipeline or as multiple processing pipelines. The number of processing pipelines typically is a function of the processing power needed for the particular application. For example, a processor for a personal workstation typically will require fewer pipelines than are required in a supercomputing system.

In addition to processing core 12, processor chip 10 comprises one or more banks of memory 14. As illustrated in FIG. 1, any number of banks of memory can be placed on processor chip 10. As one skilled in the art will appreciate, the amount of memory 14 configured on chip 10 is limited by current silicon processing technology. As transistor and line geometries decrease, the total amount of memory that can be placed on a processor chip 10 will increase.

Connected between processing core 12 and memory 14 is a memory controller 20. Memory controller 20 communicates with processing core 12 and memory 14, and handles the memory I/O requests to memory 14 from processing core 12 and from other processors and I/O devices. Connected to memory controller 20 is a distributed shared memory (DSM) controller 22, which controls and routes I/O requests and data messages from processing core 12 to off-chip devices, such as other processor chips and/or I/O peripheral devices. In addition, as discussed in more detail below, DSM controller 22 is configured to receive I/O requests and data messages from off-chip devices, and route the requests and messages to memory controller 20 for access to memory 14 or processing core 12.

High-speed I/O link 26 is connected to the DSM controller 22. In accordance with this aspect of the present invention, DSM controller 22 communicates with other processor chips and I/O peripheral devices across the I/O link 26. For example, DSM controller 22 sends I/O requests and data messages to other devices via I/O link 26. Similarly, DSM controller 22 receives I/O requests from other devices via the link.

Processor chip 10 further comprises an external memory interface 24. External memory interface 24 is connected to memory controller 20 and is configured to communicate memory I/O requests from memory controller 20 to external memory. Finally, as mentioned briefly above, processor chip 10 further comprises a boot interface 28 and a diagnostic interface 30. Boot interface 28 is connected to processing core 12 and is configured to receive a bootstrap program for cold booting processing core 12 when needed. Similarly, diagnostic interface 30 also is connected to processing core 12 and configured to provide external access to the processing core for diagnostic purposes.

### Processing Core

1. GENERAL CONFIGURATION

As mentioned briefly above, processing core 12 comprises a scalable VLIW processing core, which may be configured as a single processing pipeline or as multiple processing pipelines. A single processing pipeline can function as a single pipeline processing one instruction at a time, or as a single VLIW pipeline processing multiple sub-instructions in a single VLIW instruction word. Similarly, a multi-pipeline processing core can function as multiple autonomous processing cores. This enables an operating system to dynamically choose between a synchronized VLIW operation or a parallel multi-threaded paradigm. In multi-threaded mode, the VLIW processor manages a number of strands executed in parallel.

In accordance with one embodiment of the present invention, when processing core 12 is operating in the synchronized VLIW operation mode, an application program compiler typically creates a VLIW instruction word comprising a plurality of sub-instructions appended together, which are then processed in parallel by processing core 12. The number of sub-instructions in the VLIW instruction word matches the total number of available processing paths in the processing core pipeline. Thus, each processing path processes VLIW sub-instructions so that all the sub-instructions are processed in parallel. In accordance with this particular aspect of the present invention, the sub-instructions in a VLIW instruction word issue together in this embodiment. Thus, if one of the processing paths is stalled, all the sub-instructions will stall until all of the processing paths clear. Then, all the sub-instructions in the VLIW instruction word will issue at the same time. As one skilled in the art will appreciate, even though the sub-instructions issue simultaneously, the processing of each sub-instruction may complete at different times or clock cycles, because different sub-instruction types may have different processing latencies.

In accordance with an alternative embodiment of the present invention, when the multi-pipelined processing core is operating in the parallel multi-threaded mode, the program sub-instructions are not necessarily tied together in a VLIW instruction word. Thus, as instructions are retrieved from an instruction cache, the operating system determines which pipeline is to process each sub-instruction for a strand. Thus, with this particular configuration, each pipeline can act as an independent processor, processing a strand independent of strands in the other pipelines. In addition, in accordance with one embodiment of the present invention, by using the multi-threaded mode, the same program sub-instructions can be processed simultaneously by two separate pipelines using two separate blocks of data, thus achieving a fault tolerant processing core. The remainder of the discussion herein will be directed to a synchronized VLIW operation mode. However, the present invention is not limited to this particular configuration.

2. VERY LONG INSTRUCTION WORD (VLIW)

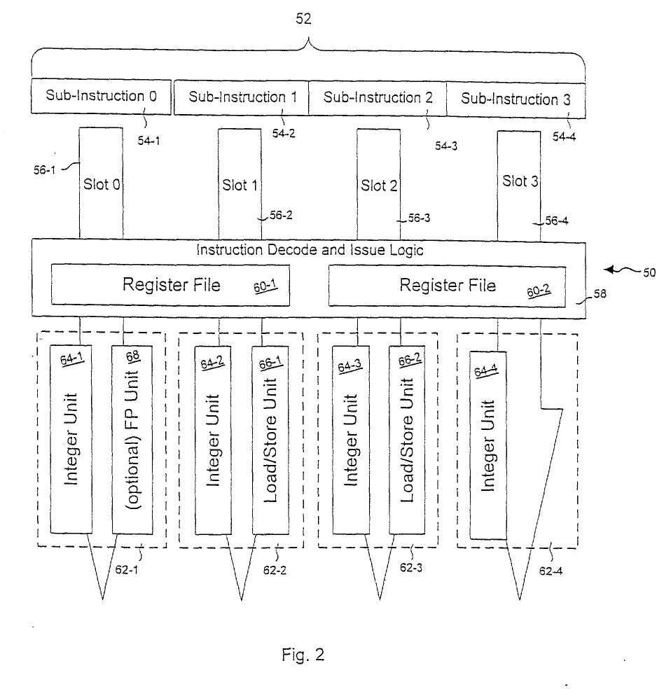

Referring now to FIG. 2, a simple block diagram of a VLIW processing core pipeline 50 having four processing paths, 56-1 to 56-4, is shown. In accordance with the illustrated embodiment, a VLIW 52 comprises four RISC-like sub-instructions, 54-1, 54-2, 54-3, and 54-4, appended together into a single instruction word. For example, an instruction word of one hundred and twenty-eight bits is divided into four thirty-two bit sub-instructions. The number of VLIW sub-instructions 54 correspond to the number of processing paths 56 in processing core pipeline 50. Accordingly, while the illustrated embodiment shows four sub-instructions 54 and four processing paths 56, one skilled in the art will appreciate that the pipeline 50 may comprise any number of sub-instructions 54 and processing paths 56. Typically, however, the number of sub-instructions 54 and processing paths 56 is a power of two.

Each sub-instruction 54 in this embodiment corresponds directly with a specific processing path 56 within the pipeline 50. Each of the sub-instructions 54 are of similar format and operate on one or more related register files 60. For example, processing core pipeline 50 may be configured so that all four sub-instructions 54 access the same register file, or processing core pipeline 50 may be configured to have multiple register files 60. In accordance with the illustrated embodiment of the present invention, sub-instructions 54-1 and 54-2 access register file 60-1, and sub-instructions 54-3 and 54-4 access register file 60-2. As those skilled in the art can appreciate, such a configuration can help improve performance of the processing core.

As illustrated in FIG. 2, an instruction decode and issue logic stage 58 of the processing core pipeline 50 receives VLIW instruction word 52 and decodes and issues the sub-instructions 54 to the appropriate processing paths 56. Each sub-instruction 54 then passes to the execute stage of pipeline 50 which includes a functional or execute unit 62 for each processing path 56. Each functional or execute unit 62 may comprise an integer processing unit 64, a load/store processing unit 66, a floating point processing unit 68, or a combination of any or all of the above. For example, in accordance with the particular embodiment illustrated in FIG. 2, the execute unit 62-1 includes an integer processing unit 64-1 and a floating point processing unit 68; the execute unit 62-2 includes an integer processing unit 64-2 and a load/store processing unit 66-1; the execute unit 62-3 includes an integer processing unit 64-3 and a load/store unit 66-2; and the execute unit 62-4 includes only an integer unit 64-4.

As one skilled in the art will appreciate, scheduling of sub-instructions within a VLIW instruction word 52 and scheduling the order of VLIW instruction words within a program is important so as to avoid unnecessary latency problems, such as load, store and writeback dependencies. In accordance with the one embodiment of the present invention, the scheduling responsibilities are primarily relegated to the software compiler for the application programs. Thus, unnecessarily complex scheduling logic is removed from the processing core, so that the design implementation of the processing core is made as simple are possible. Advances in compiler technology thus result in improved performance without redesign of the hardware. In addition, some particular processing core implementations may prefer or require certain types of instructions to be executed only in specific pipeline slots or paths to reduce the overall complexity of a given device. For example, in accordance with the embodiment illustrated in FIG. 2, since only processing path 56-1, and in particular execute unit 62-1, include a floating point processing unit 68, all floating point sub-instructions are dispatched through path 56-1. As discussed above, the compiler is responsible for handling such issue restrictions in this embodiment.

In accordance with a one embodiment of the present invention, all of the sub-instructions 54 within a VLIW instruction word 52 issue in parallel. Should one of the sub-instructions 54 stall (i.e., not issue), for example due to an unavailable resource, the entire VLIW instruction word 52 stalls until the particular stalled sub-instruction 54 issues. By ensuring that all sub-instructions within a VLIW instruction word 52 issue simultaneously, the implementation logic is dramatically simplified.

3. DATA TYPES

The registers within the processor chip are arranged in varying data types. By having a variety of data types, different data formats can be held in a register. For example, there may be different data types associated with signed integer, unsigned integer, single-precision floating point, and double-precision floating point values. Additionally, a register may be subdivided or partitioned to hold a number of values in separate fields. These subdivided registers are operated upon by single instruction multiple data (SIMD) instructions.

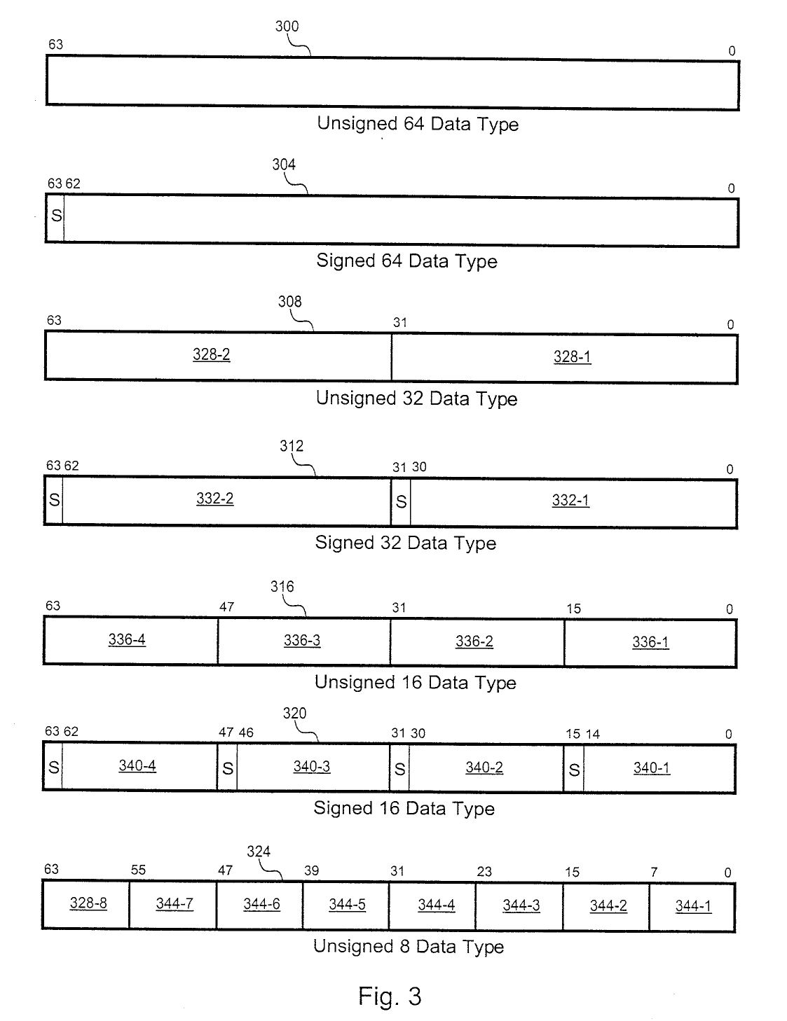

With reference to FIG. 3, some of the data types available for the sub-instructions are shown. In this embodiment, the registers are sixty-four bits wide. Some registers are not subdivided to hold multiple values, such as the signed and unsigned 64 data types 300, 304. However, the partitioned data types variously hold two, four or eight values in the sixty-four bit register. The data types that hold two or four data values can hold the same number of signed or unsigned integer values. The unsigned 32 data type 304 holds two thirty-two bit unsigned integers while the signed 32 data type 308 holds two thirty-two bit signed integers 328. Similarly, the unsigned 16 data type 312 holds four sixteen bit unsigned integers 332 while the signed 16 data type 316 holds four sixteen bit signed integers 340.

Although one embodiment operates upon sixteen bit data types where four operands are stored in each register, smaller or larger processing widths could have different relationships. For example, a processor with a thirty-two bit processing width could store eight bit values in each register or thirty-two bit values for a one hundred and twenty eight bit processing width. As those skilled in the art appreciate, there are other possible data types and this invention is not limited to those described above.

Although there are a number of different data types, a given sub-instruction 54 may only utilize a subset of these. For example, the below-described embodiment of the matrix transpose sub-instruction only utilizes the unsigned 16 data type. However, other embodiments could use different data types.

4. MATRIX TRANSPOSE INSTRUCTION

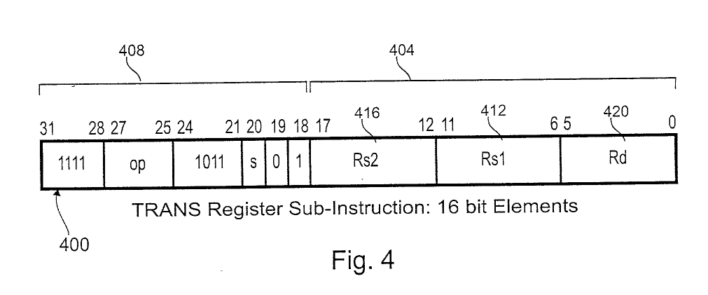

Referring next to FIG. 4, the machine code for a matrix transpose sub-instruction (“TRANS”) 400 is shown. This variation of the sub-instruction addressing forms is generally referred to as the register addressing form 400. The sub-instruction 400 is thirty-two bits wide such that a four-way VLIW processor with an one hundred and twenty-eight bit wide instruction word 52 can accommodate execution of four sub-instructions 400 at a time. The sub-instruction 400 is divided into an address and op code portions 404, 408. Generally, the address portion 404 contains the information needed to load and store the operators, and the op code portion 408 indicates which function to perform upon the operators.

The register form of the sub-instruction 400 utilizes three registers. A first and second source addresses 412, 416 are used to load a first and second source registers which each contain a number of source operands in separate fields. A destination address 420 is used to indicate where to store the results into separate fields of a destination register. In this embodiment, each register uses an unsigned 16 data type 316 which has four fields having sixteen bit values stored within. Since each register 412, 416, 420 is addressed with six bits in this embodiment, sixty-four registers are possible in an on-chip register file 60. In this embodiment, all loads and stores are performed with the on-chip register file 60. However, other embodiments could allow addressing registers outside the processing core 12. Bits 31-18 of the register form 400 of the sub-instruction are the op codes 408 which are used by the processing core 12 to execute the sub-instruction 54. Various sub-instruction types may have differing amounts of bits devoted to op codes 408.

In this embodiment, the two transpose sub-instructions (“TRANS”) are issued at a time to adjacent processing paths 56 of a VLIW processor. The processing paths have access to each other's register files or may have a unified register file. The paired sub-instructions load from each other's source registers and store to each other's destination registers. The order of the sub-instructions indicates the contents of the source and destination registers available to the sub-instructions.

Most bits of the op code 408 are fixed except bit 20. Bit 20 (“s”) of the op code 408 differentiates the two forms of this sub-instruction. As is discussed further below, the first form (“TRANS0”) produces the first and third rows of the transposed matrix and the second form (“TRANS1”) produces the second and fourth rows. The first and second forms of the sub-instruction can issue in any order or issue simultaneously in a four-way VLIW processor.

The sub-instruction 400 executes differently depending on whether execution is down the left or right processing path 56. The compiler places each matrix transpose sub-instruction 400 in the proper order in the VLIW instruction 52 such that the proper processing path 56 receives its respective sub-instruction as part of the same issue. For example, an improper result would occur if two TRANS0 commands were issued sequentially for the same processing path 56 rather than simultaneously on adjacent processing paths 56. Non-adjacent processing paths 56 are not necessary, but there should be common source registers or some other communication between the processing paths 56. Some embodiments could issue the sub-instruction 400 down non-adjacent processing paths 56 or in different issues so long as the sub-instruction explicitly encodes which portion of the transposed matrix should be produced by the sub-instruction.

Typically, a compiler is used to convert assembly language or a higher level language into machine code that contains the op codes. As is understood by those skilled in the art, the op codes control multiplexes, other combinatorial logic and registers to perform a predetermined function. Furthermore, those skilled in the art appreciate there could be many different ways to implement op codes.

5. MATRIX TRANSPOSE IMPLEMENTATION

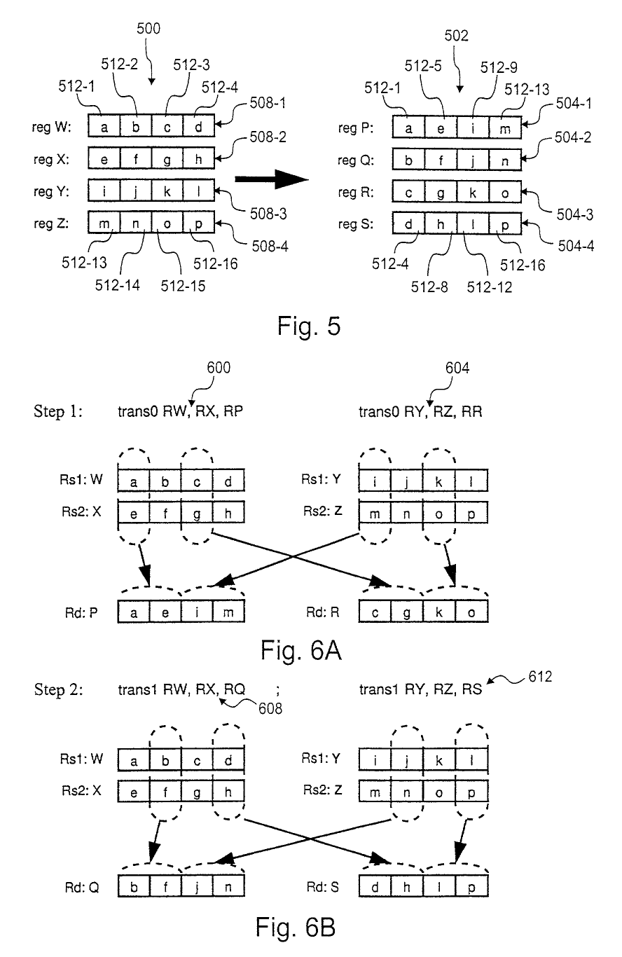

With reference to FIG. 5, a diagram schematically illustrates one embodiment of the matrix transpose operation. A matrix is an rectangular array of elements. The transpose operations (“TRANS”) convert the matrix 500 into a transposed matrix 502. In this embodiment, the matrix 500 is square and has four columns and four rows. Before performing the transpose operation, the four rows are in four source registers 508. After the transpose, the four columns are in four destination registers 504. The registers 508, 504 have separate fields that store the elements 512. The sixteen elements 512 are sequentially lettered “a” 512-1 through “p” 512-16. After the transpose operation, the rows of the matrix 500 become columns of the transposed matrix 502 and the columns become rows.

Although the above-described embodiment operates upon a four-by-four matrix, any size of matrix can be transposed using the transpose operations. Larger matrixes are broken into four-by-four chunks and manipulated separately. All the separate manipulations are assembled into the transposed result.

Referring next to FIG. 6A, a first step that includes two TRANS0 sub-instructions is shown. The first TRANS0 sub-instruction 600 addresses the first and second rows as first and second source registers 508-1, 508-2 and the first column as a first destination register 504-1. Likewise, the second TRANS0 sub-instruction 604 addresses the third and fourth rows as third and fourth source registers 508-3, 508-4 and the third column as a third destination register 504-3. Both TRANS0 sub-instructions 600, 604 load matrix elements 512 from all source registers 508 and store to both the first and third destination registers 504-1, 504-3. In contrast, instructions typically do not operate on registers not addressed by those instructions.

The first TRANS0 sub-instruction 600 arranges the first column of elements 512-1, 512-5, 512-9, 512-13 in the first destination register 504-1. The first and fifth elements 512-1, 512-5 are respectively loaded from the first and second source registers 508-1, 508-2 of the matrix 500. These elements 512-1, 512-5 are stored in the first two fields of the first destination register 504-1. Next, the ninth and thirteenth elements 512-9, 512-13 are respectively loaded from the third and fourth source registers 508-3, 508-4 and stored in the second two fields of the first destination register 504-1. In this way, the first row of the transposed matrix 502 is determined.

In a similar manner, the second TRANS0 sub-instruction 604 arranges the third column of elements 512-3, 512-7, 512-11, 512-15 in the third destination register 504-3. The third and seventh elements 512-3, 512-7 are respectively loaded from the first and second source registers 508-1, 508-2 of the matrix 500. These elements 512-3, 512-7 are stored in the first two fields of the third destination register 504-3. Next, the eleventh and fifteenth elements 512-11, 512-15 are respectively loaded from the third and fourth source registers 508-3, 508-4 and stored in the second two fields of the third destination register 504-3. In this way, the third row of the transposed matrix 502 is determined.

With reference to FIG. 6B, a second step that includes two TRANS1 sub-instructions is shown. The first TRANS1 sub-instruction 608 addresses the first and second rows as first and second source registers 508-1, 508-2 and the second column as a second destination register 504-2. Likewise, the second TRANS1 sub-instruction 612 addresses the third and fourth rows as third and fourth source registers 508-3, 508-4 and the fourth column as a fourth destination register 504-4. Both TRANS1 sub-instructions 608, 612 load matrix elements 512 from all source registers 508 and store to both the second and fourth destination registers 504-2, 504-4.

The first TRANS1 sub-instruction 608 arranges the second column of elements 512-2, 512-6, 512-10, 512-14 in the second destination register 504-2. The second and sixth elements 512-2, 512-6 are respectively loaded from the first and second source registers 508-1, 508-2 of the matrix 500. These elements 512-2, 512-6 are stored in the first two fields of the second destination register 504-2. Next, the tenth and fourteenth elements 512-10, 512-14 are respectively loaded from the third and fourth source registers 508-3, 508-4 and stored in the second two fields of the second destination register 504-2. In this way, the second row of the transposed matrix 502 is determined.

Likewise, the second TRANS1 sub-instruction 612 arranges the fourth column of elements 512-4, 512-8, 512-12, 512-16 in the fourth destination register 504-4. The fourth and eighth elements 512-4, 512-8 are respectively loaded from the first and second source registers 508-1, 508-2 of the matrix 500. These elements 512-4, 512-8 are stored in the first two fields of the fourth destination register 504-4. Next, the twelfth and sixteenth elements 512-12, 512-16 are respectively loaded from the third and fourth source registers 508-3, 508-4 and stored in the second two fields of the fourth destination register 504-4. In this way, the fourth row of the transposed matrix 502 is determined.

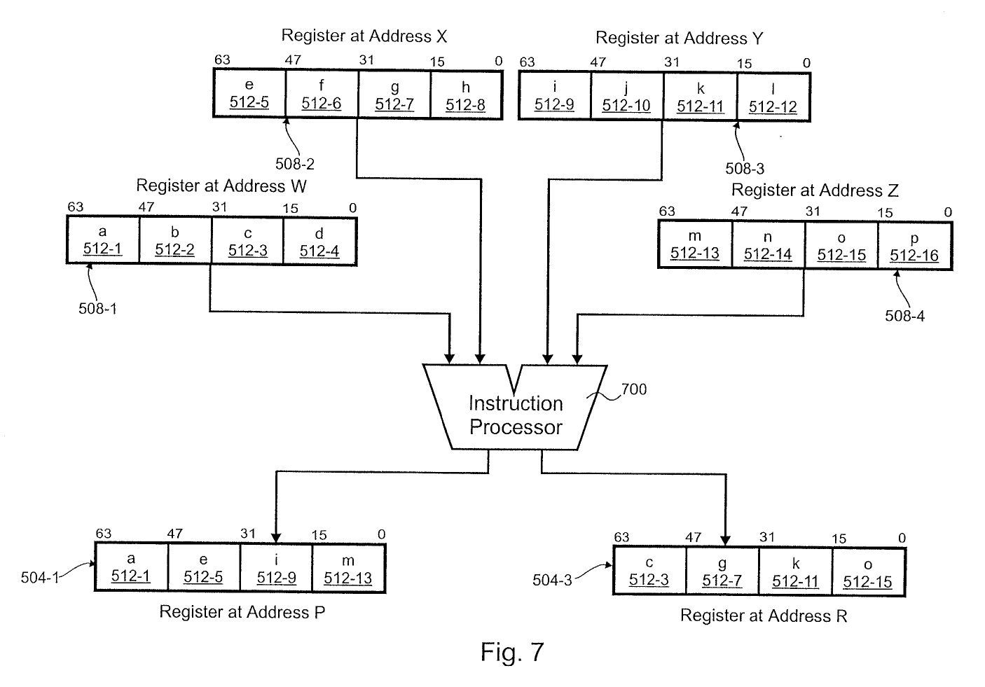

Next referring to FIG. 7, a block diagram that schematically depicts the TRANS0 sub-instruction is shown. Each source register 508 is sixty-four bits wide and includes four sixteen-bit fields. Each field stores an element 512. In this embodiment, the elements are unsigned integer values. As discussed above, the first and second source registers 508-1, 508-2 and the first destination register 504-1 are addressed by a first TRANS0 sub-instruction 600. Likewise, the third and fourth source registers 508-3, 508-4 and the third destination register 504-3 are addressed by a second TRANS0 sub-instruction 604. These two TRANS0 sub-instructions work in concert to store the first column 504-1 of the matrix 500 in the first destination register and store the third column 504-3 of the matrix 500 in the third destination register 504-3.

An instruction processor 700 loads the elements 512 from the source register 508 and stores them in the appropriate destination registers. Included in the instruction processor 700 are inputs coupled to the source registers 508 and outputs coupled to the destination registers 504. The instruction processor 700 also includes multiplexers or the like, that implement the redirection of data from the source registers 508 to the appropriate destination registers 512. Additional multiplexers could switch between modes for the two different variations of this sub-instruction (i.e., TRANS0, TRANS1) such that the same instruction processor 700 could perform both variations of this instruction.

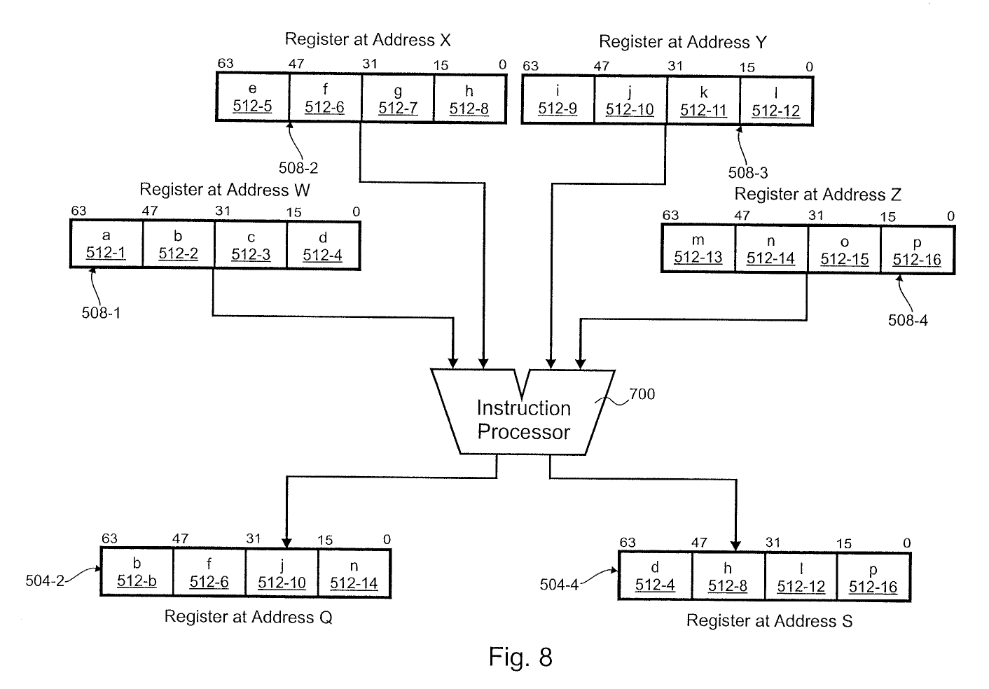

With reference to FIG. 8, a block diagram that schematically depicts the TRANS1 sub-instruction is shown. The TRANS1 sub-instruction works in concert with the TRANS0 sub-instruction depicted in FIG. 7 to transpose a sixteen-element 512 square matrix 500. Since the TRANS0 and TRANS1 sub-instructions are not interrelated, they may be executed in any order or even simultaneously. In this embodiment, simultaneous issue would require a four-way VLIW processor.

The two TRANS1 sub-instructions work together to store the second column 504-2 of the matrix 500 in the second destination register and store the fourth column 504-4 of the matrix 500 in the fourth destination register 504-4. As discussed in relation to FIG. 6B above, the first and second source registers 508-1, 508-2 and the second destination register 504-2 are addressed by a first TRANS1 sub-instruction 608. Likewise, the third and fourth source registers 508-3, 508-4 and the fourth destination register 504-4 are addressed by a second TRANS1 sub-instruction 612. The instruction processor 700 performs the loading from the source registers 508 and storing to the destination registers 504.

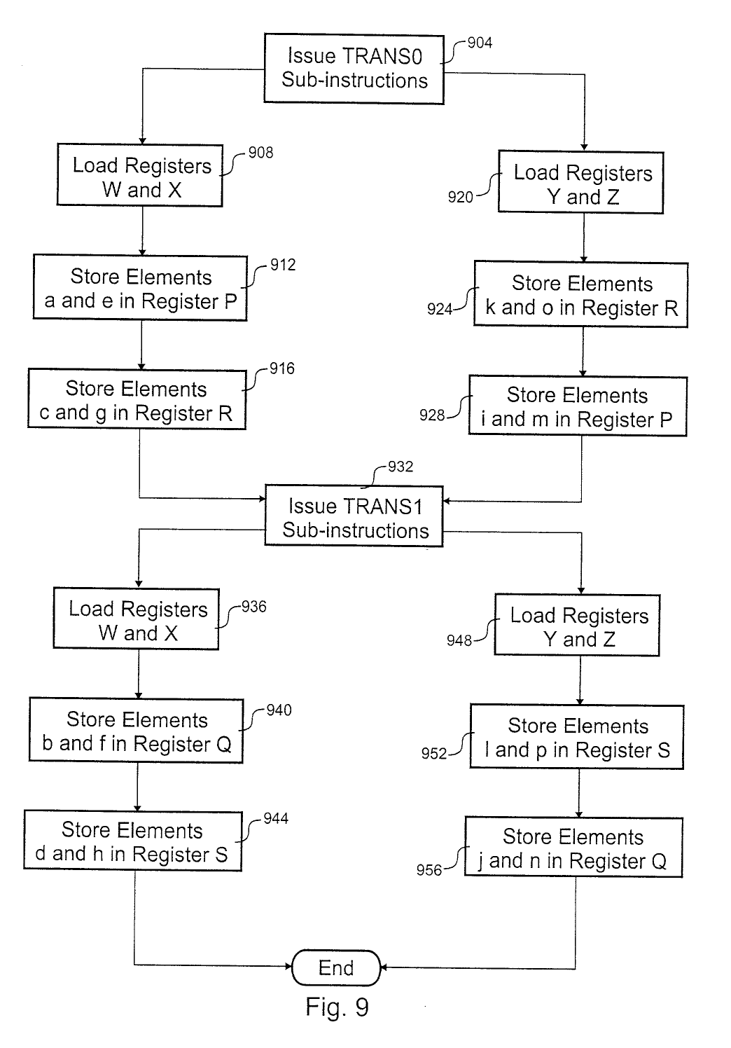

Referring next to FIG. 9, a flow diagram depicts the matrix transpose process where the TRANS0 sub-instructions 600, 604 and TRANS1 sub-instructions 608, 612 are issued sequentially in that order. In step 904, the two TRANS0 sub-instructions 600, 604 issue in separate processing paths of the 56 of the VLIW processor. The first TRANS0 sub-instruction 604 loads the first and second source registers 508-1, 508-2 in step 908. The first, third, fifth, and seventh elements 512-1, 512-3, 512-5, 512-7 are written to their respective destination registers 504-1, 504-3 in steps 912 and 916.

The third and fourth source registers 508-3, 508-4 are loaded in step 920 by the second TRANS0 sub-instruction 604. In steps 924 and 928, the ninth, eleventh, thirteenth, and fifteenth elements 512-9, 512-11, 512-13, 512-15 are written to their respective destination registers 504-1, 504-3.

In step 932, the two TRANS1 sub-instructions 608, 612 issue in separate processing paths of the 56 of the VLIW processor. The first TRANS1 sub-instruction 608 loads the first and second source registers 508-1, 508-2 in step 936. In steps 940 and 944, the second, fourth, sixth, and eighth elements 512-2, 512-4, 512-6, 512-8 are written to their respective destination registers 504-2, 504-4.

The third and fourth source registers 508-3, 508-4 are loaded in step 948 by the second TRANS1 sub-instruction 612. The tenth, twelfth, fourteenth, and sixteenth elements 512-10, 512-12, 512-14, 512-16 are written to their respective destination registers 504-2, 504-4 in steps 952 and 956. In this way, a four by four matrix is transposed in two very long instruction words.

Although the above embodiments variously describe a two or four-way VLIW processor which operate upon a sixteen element matrix, other embodiments of different configurations are possible. The sole table indicates some of the possible variations of this invention for performing a transpose in one issue, however other variations are also possible. All the variations in the table presume a sixteen-element matrix. For example, a two way VLIW architecture with two processing paths and sixteen bit wide elements in one hundred and twenty-eight bit wide registers could perform a sixteen-element transpose in one issue.

| VLIW Processor | Width of Elements | Width of Registers |
|---|---|---|
| Two-Way | 8 bit | 64 bit |
| Four-Way | 16 bit | 64 bit |
| Eight-Way | 32 bit | 64 bit |
| Sixteen-Way | 64 bit | 64 bit |
| One-Way | 8 bit | 128 bit |
| Two-Way | 16 bit | 128 bit |
| Four-Way | 32 bit | 128 bit |
| Eight-Way | 64 bit | 128 bit |

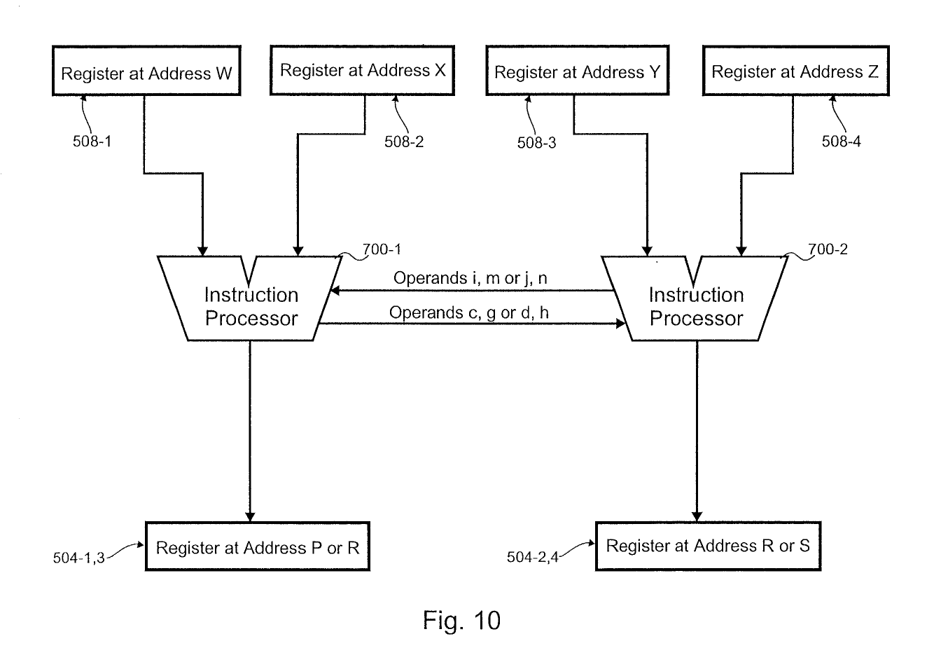

With reference to FIG. 10, a block diagram that schematically illustrates another embodiment of the operation that in two issues successively transposes all rows of the matrix. Two source registers 508-1, 508-2 are associated with a first register file 60-1 and the other two source registers 508-3, 508-4 are associated with a second register file 60-1. When two TRANS0 sub-instructions 600, 604 are executed in the first instruction word 52, the right and left processing paths 56 pass operands to each other by way of the instruction processors 700. More specifically, operands i and m 512-9, 512-13 are passed from the left instruction processor 700-2 to the right instruction processor 700-1 in exchange for operands c and g 512-3, 512-7 being passed from the right instruction processor 700-1 to the left instruction processor 700-2. The two TRANS0 sub-instructions 600, 604 output to registers 504-1, 504-2 in their respective register files 60.

In performing the two TRANS1 sub-instructions 608, 612, a similar processor occurs. During execution of the second instruction word 52, operands j and n 512-10, 512-14 are passed from the left instruction processor 700-2 to the right instruction processor 700-1 in exchange for operands d and h 512-4, 512-8 being passed from the right instruction processor 700-1 to the left instruction processor 700-2. The two TRANS1 sub-instructions 608, 612 output to registers 504-3, 504-4 in their respective register files 60. This embodiment does not require a common register file by communicating between the two processing paths 56 issuing the two matrix transpose sub-instructions.

### Conclusion

In conclusion, the present invention provides a novel computer processor chip having an sub-instruction for efficiently performing a matrix transpose operation. Embodiments of this sub-instruction allow performing a transpose operation in as little as one VLIW instruction issue. While a detailed description of presently preferred embodiments of the invention is given above, various alternatives, modifications, and equivalents will be apparent to those skilled in the art. For example, while the above embodiments generally relate to square matrices, those skilled in the art can extend the above concepts to transpose rectangular matrices also. In addition, different embodiments could store different formatted data as elements such as ASCII text, signed values, floating point values, etc. Therefore, the above description should not be taken as limiting the scope of the invention that is defined by the appended claims.

What is claimed is:

1. A method for processing a matrix of elements in a processor, the method comprising steps of:
loading a first subset of matrix elements from a first location;
loading a second subset of matrix elements from a second location;
storing a third subset of matrix elements in a first destination; and
storing a fourth subset of matrix elements in a second destination, wherein the loading and storing steps result from a first instruction issue.

2. The method for processing the matrix of elements in the processor as recited in claim 1, wherein n sub-instructions perform an n-by-n matrix transpose.

3. The method for processing the matrix of elements in the processor as recited in claim 1, wherein the first loading step is performed with a first processing path and the second loading step is performed with a second processing path.

4. The method for processing the matrix of elements in the processor as recited in claim 1, further comprising the steps of:
loading a fifth subset of matrix elements from a fifth location;
loading a sixth subset of matrix elements from a sixth location;
storing a seventh subset of matrix elements in a third destination; and
storing a eighth subset of matrix elements in a fourth destination.

5. The method for processing the matrix of elements in the processor as recited in claim 4, wherein the loading and storing steps introduced in claim 4 result from a second instruction issue.

6. The method for processing the matrix of elements in the processor as recited in claim 4, wherein each of the first through fourth destination include a matrix column.

7. The method for processing the matrix of elements in the processor as recited in claim 1, wherein each of the first through fourth locations include a matrix row.

8. The method for processing the matrix of elements in the processor as recited in claim 1, wherein the third and fourth subsets each comprise elements from the first and second subsets.

9. A processing core for transposing a matrix, comprising:
a first source location comprising a first plurality of matrix elements;
a second source register comprising a second plurality of matrix elements;
a third source register comprising a third plurality of matrix elements;
a fourth source register comprising a fourth plurality of matrix elements;
a first destination register comprising a fifth plurality of matrix elements;
a second destination register comprising a sixth plurality of matrix elements;
a first processing path coupled to the first through fourth source registers and the first destination register; and
a second processing path coupled to the first through fourth source registers and the second destination register.

10. The processing core for transposing the matrix of claim 9, wherein:
the first through fourth registers each include a plurality of source fields, and
each source field includes a matrix element.

11. The processing core for transposing the matrix of claim 9, wherein:
the first and second destination registers each include a plurality of result fields, and
each source field includes a matrix element.

12. The processing core for transposing the matrix of claim 9, further comprising
first and second instruction processors; and
an exchange path between the first and second instruction processors.

13. The processing core for transposing the matrix of claim 9, wherein the first processing path receives a first sub-instruction and the second processing path receives a second sub-instruction.

14. The processing core for transposing the matrix of claim 9, wherein each of the first through fourth source registers include a matrix row.

15. The processing core for transposing the matrix of claim 9, wherein each of the first and second destination registers include a matrix column.

16. The processing core for transposing the matrix of claim 9, wherein the first and second destination registers are addressed by a first and second sub-instructions which are included in a very long instruction word.

17. A method for processing a matrix of elements, the method comprising steps of:
loading a first instruction;
loading a second instruction, wherein the first and second instructions address a first source register, second source register, third source register, fourth source register, first destination register and second destination register;
loading a third instruction;
loading a fourth instruction, wherein the third and fourth instructions address the first source register, the second source register, the third source register, the fourth source register, a third destination register and a fourth destination register;
storing a first element of the first source register in the first destination register; and
storing a fourth element of the first source register in the fourth destination register, wherein a plurality of the first through fourth elements comprise a same instruction issue.

18. The method for processing the matrix of elements of claim 17, wherein the first and second instructions include a first operation code and the third and fourth instructions include a second operation code different from the first operation code.

19. The method for processing the matrix of elements of claim 17, wherein the first and second instructions include a first operation code and the third and fourth instructions include a second operation code different from the first operation code.

20. The method for processing the matrix of elements of claim 17, wherein the first instruction is a sub-instruction in a very long instruction word.
